(19) United States
(12) Patent Application Publication
(10) Pub. No.: US 2019/0335062 A1
(43) Pub. Date: Oct. 31, 2019

(54) MEMORY CONTROLLER, NON-VOLATILE STORAGE DEVICE, NON-VOLATILE STORAGE SYSTEM, AND MEMORY CONTROL METHOD

(71) Applicant: Panasonic Intellectual Property Management Co., Ltd., Osaka (JP)

(72) Inventors: Hirokazu SOU, Kyoto (JP); Toshiyuki HONDA, Kyoto (JP); Shigekazu KOGITA, Kanagawa (JP); Masato SUTO, Osaka (JP)

(21) Appl. No.: 16/379,124

(22) Filed: Apr. 9, 2019

(30) Foreign Application Priority Data
Apr. 25, 2018 (JP) 2018-083668

(51) Int. Cl. H04N 1/44; G06F 12/10; G06F 21/60; H04N 1/32

(52) U.S. Cl. CPC H04N 1/4473; G06F 12/10; G06F 21/604; H04N 2201/0094; G06F 2212/1052; G06F 2212/657; H04N 1/32358

(57) ABSTRACT

A memory controller includes a data discard controller, calculates a physical address of discard object data designated by a logical address by a host device, and registers the calculated physical address as discard object data information. With respect to a predetermined command from the host device, the data discard controller outputs current discard object data information to the host device. When no command is received from the host device, the data discard controller physically erases the discard object data on the basis of the discard object data information.

### BACKGROUND

### 1. Technical Field

The present disclosure relates to a memory controller that controls a data-rewritable non-volatile memory, and relates to a non-volatile storage device, a non-volatile storage system, and a memory control method.

### 2. Description of the Related Art

Electronic equipment such as a multifunction peripheral (MFP) stores confidential data such as image data in a storage device. Confidential data that has become unnecessary after being stored in the storage device is required to be physically discarded promptly from a security point of view (see NPL 1, for example).

Conventionally, a hard disk drive (HDD) capable of storing a large volume of data has been used as a storage device for an MFP. As a method for physically discarding the data stored in the HDD, a method has been common in which the data is overwritten once or more with another data.

In recent years, flash memories (non-volatile memories) have rapidly become larger in capacity and lower in cost, and it is thus expected that a storage device in an MFP will be replaced by a non-volatile storage device such as a solid-state drive (SSD), which is higher in speed and lower in power consumption.

### CITATION LIST

### Non-Patent Literature

NPL1: Information-technology Promotion Agency (Sep. 10, 2015). Protection Profile for Hardcopy Devices (digital multifunctional peripherals), page 26

### SUMMARY

With respect to a flash memory mounted on a non-volatile storage device, the number of rewrite times is limited; therefore, a non-volatile storage device generally has an address management table, and data is written to be dispersed throughout the flash memory so that a rewrite lifetime is improved.

However, the address (logical address) assigned by the MFP on the basis of the address management table is variably linked to the address of the flash memory (physical address). Thus, even if confidential data written with a logical address designated by the MFP is overwritten with another data with the same logical address designated by the MFP, the confidential data is sometimes not physically overwritten and remains in the flash memory.

Therefore, there is a problem that the MFP (host device) cannot check a state of the confidential data stored in the SSD and cannot perform control to physically discard the confidential data.

The present disclosure provides a memory controller, a non-volatile storage device, a non-volatile storage system, and a memory control method in which a control can be performed such that a state of confidential data is checked from a host device and the confidential data is physically discarded.

A memory controller of the present disclosure writes and reads data into and from a non-volatile memory having a plurality of physical blocks, and the memory controller includes a control unit and a host interface. The control unit manages (i) an address mapping table that manages correspondence between a logical address designated by an external device and the plurality of physical blocks and (ii) discard object data information generated by converting data about a discard object designated by the logical address by the external device into information about the plurality of physical blocks, and the control unit discards data based on the discard object data information. The host interface unit is connected to the external device to transmit and receive data to and from the external device. When the control unit has received an instruction to acquire a discard state of data from the host interface unit, the control unit outputs information about unprocessed discard object data with reference to the discard object data information.

The memory controller, the non-volatile storage device, the non-volatile storage system, and the memory control method in the present disclosure can perform control such that a state of confidential data is checked from a host device and the confidential data is physically discarded. The host device can therefore perform control of non-volatile storage device such that confidential data that has become unnecessary is physically discarded promptly.

### BRIEF DESCRIPTION OF THE DRAWINGS

FIG. 1 is a diagram showing a configuration of a non-volatile storage system in a first exemplary embodiment;

FIG. 2 is a diagram showing a configuration of an address mapping table in the first exemplary embodiment;

FIG. 3 is a diagram showing a configuration of a physical block management table in the first exemplary embodiment;

FIG. 4 is a diagram showing a configuration of discard object data information in the first exemplary embodiment;

FIG. 5 is a diagram showing a configuration of physical blocks as a recording area in a non-volatile memory in the first exemplary embodiment;

FIG. 6 is a diagram showing a configuration of physical pages of a physical block in the first exemplary embodiment;

FIG. 7 is a diagram showing a configuration of a host device in the first exemplary embodiment;

FIG. 8 is a flowchart showing an operation of the non-volatile storage device in the first exemplary embodiment after power is turned on;

FIG. 9 is a flowchart showing an operation of the non-volatile storage device in the first exemplary embodiment when a write command has been received;

FIG. 10 is a diagram showing an example of states of an address mapping table, a physical block management table, discard object data information, physical block #4, physical block #5 in the first exemplary embodiment when a write command has been received;

FIG. 11 is a diagram showing an example of the states of the address mapping table, the physical block management table, the discard object data information, physical block #4, physical block #5 after a write command is processed in the first exemplary embodiment;

FIG. 12 is a flowchart of an operation in the first exemplary embodiment when the discard registration command has been received;

FIG. 13 is a diagram showing an example of the states of the address mapping table, the physical block management table, the discard object data information, physical block #4, physical block #5 after a discard registration command is processed in the first exemplary embodiment;

FIG. 14 is a flowchart of an operation in the first exemplary embodiment when a discard-state acquisition command has been received;

FIG. 15 is a diagram showing an example of output data as a response to a discard-state acquisition command in the first exemplary embodiment before a garbage collection (GC) and data discard process is performed;

FIG. 16 is a flowchart showing an operation of the GC and data discard process in the first exemplary embodiment;

FIG. 17 is a diagram showing an example of the states of the address mapping table, the physical block management table, the discard object data information, physical block #4, physical block #5 after step S1604 for performing the GC and data discard process in the first exemplary embodiment;

FIG. 18 is a diagram showing an example of the states of the address mapping table, the physical block management table, the discard object data information, physical block #4, physical block #5 after the GC and data discard process is performed in the first exemplary embodiment;

FIG. 19 is a diagram showing an example of the output data as a response to the discard-state acquisition command after the GC and data discard process is performed in the first exemplary embodiment;

FIG. 20 is a flowchart showing an operation of the host device in the first exemplary embodiment after power is turned on;

FIG. 21 is a flowchart showing an operation of an image printing process on the host device in the first exemplary embodiment; and

FIG. 22 is a flowchart showing an operation of the host device in the first exemplary embodiment after a power-off process is started.

### DETAILED DESCRIPTION

Hereinafter, an exemplary embodiment will be described in detail with reference to the drawings as appropriate. However, an unnecessarily detailed description will not be given in some cases. For example, a detailed description of a well-known matter and a duplicated description of substantially the same configuration will be omitted in some cases. This is to avoid the following description from being unnecessarily redundant and thus to help those skilled in the art to easily understand the description.

Note that the accompanying drawings and the following description are provided to help those skilled in the art to sufficiently understand the present disclosure, and it is not intended to limit the subjects described in the claims

### First Exemplary Embodiment

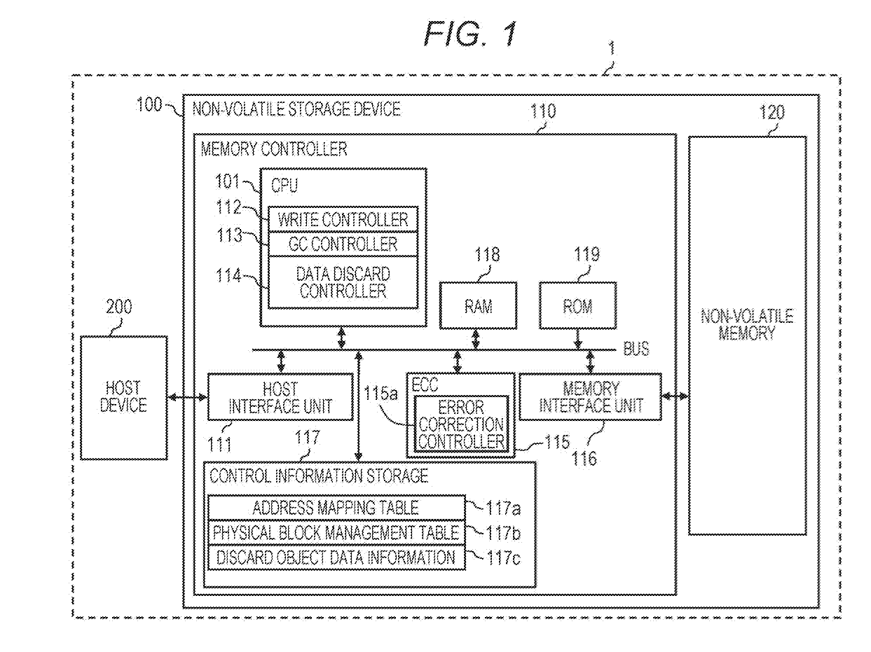

Hereinafter, a first exemplary embodiment will be described with reference to FIGS. 1 to 22.

### [1-1. Configuration]

### [1-1-1. Configuration of Non-Volatile Storage System]

FIG. 1 is a diagram showing a configuration of a non-volatile storage system in the present exemplary embodiment. With reference to FIG. 1, non-volatile storage system 1 includes non-volatile storage device 100 and host device 200, which is a higher-level device of non-volatile storage device 100.

Non-volatile storage device 100 is, for example, an SSD, which is a semiconductor memory device. Alternatively, non-volatile storage device 100 may be an SD memory card, a CompactFlash (registered trademark), a flash drive, or a memory device for embedded use. Non-volatile storage device 100 can store digital data of various contents such as still images, moving images, voices, and texts (hereinafter, referred to as “contents data”). Non-volatile storage device 100 is connectable to host device 200, which is a higher-level device. Host device 200 is an example of an external device.

Non-volatile storage device 100 includes memory controller 110 and non-volatile memory 120.

Host device 200 records contents data in non-volatile storage device 100 and reads out contents data from non-volatile storage device 100. Host device 200 is, for example, electronic equipment such as a multifunction peripheral called MFP, a digital camera, a personal computer, a smartphone, a tablet terminal, or a television set.

Non-volatile memory 120 is a storage element that can hold the contents data with no power supplied. Non-volatile memory 120 is configured with, for example, a NAND flash memory.

### [1-1-2. Configuration of Memory Controller]

Next, a configuration of memory controller 110 for non-volatile storage device 100 will be described in detail. Memory controller 110 receives a command and related address information from host device 200 and controls writing and reading of contents data in and from non-volatile memory 120.

Memory controller 110 includes central processing unit (CPU) 101, host interface unit 111, error correcting code (ECC) circuit 115, memory interface unit 116, control information storage 117, random access memory (RAM) 118, and read only memory (ROM) 119, and these components are connected to each other via a bus.

CPU 101 is a processing unit that executes various programs and the like.

Host interface unit 111 is an interface that transmits and receives data such as commands and contents data to and from host device 200, under control of CPU 101.

Memory interface unit 116 is an interface that controls writing, reading, and erasing of data with respect to non-volatile memory 120, under control of CPU 101.

ECC circuit 115 is an error correction circuit that performs a coding process of data to be stored and a decoding process of stored data. Error correction controller 115a functions by ECC circuit 115 and corrects an error having occurred in the contents data written in non-volatile memory 120.

Control information storage 117 is a memory storing control information to be processed by CPU 101 and management information about non-volatile memory 120.

RAM 118 is used as a storage area and a work area for a program to be executed by CPU 101 and for a parameter appropriately changing in a program manipulation. ROM 119 stores fixed data as a program to be executed by CPU 101 or an operation parameter.

CPU 101 includes write controller 112, a read controller (not shown), GC controller 113, and data discard controller 114.

Write controller 112 performs control to write contents data received by host interface unit 111 in non-volatile memory 120.

The read controller (not shown) performs control to output contents data stored in non-volatile memory 120 to host device 200 via host interface unit 111.

GC controller 113 performs control of a process in which the contents data that is of the contents data stored in non-volatile memory 120 and has become invalid by being overwritten or by discarding of data is collected and is reserved as an area for storing new contents data, in other words, GC controller 113 performs control of a GC process.

Data discard controller 114 performs control to physically discard the contents data stored in non-volatile memory 120 by means of physical erasure or the like.

Control information storage 117 is a storage area that stores address mapping table 117a, physical block management table 117b, and discard object data information 117c.

Alternatively, control information storage 117 may be provided not on memory controller 110 but on non-volatile memory 120, and it is also possible that a dynamic random-access memory (DRAM) accessible from memory controller 110 is prepared and that control information storage 117 is provided on the DRAM.

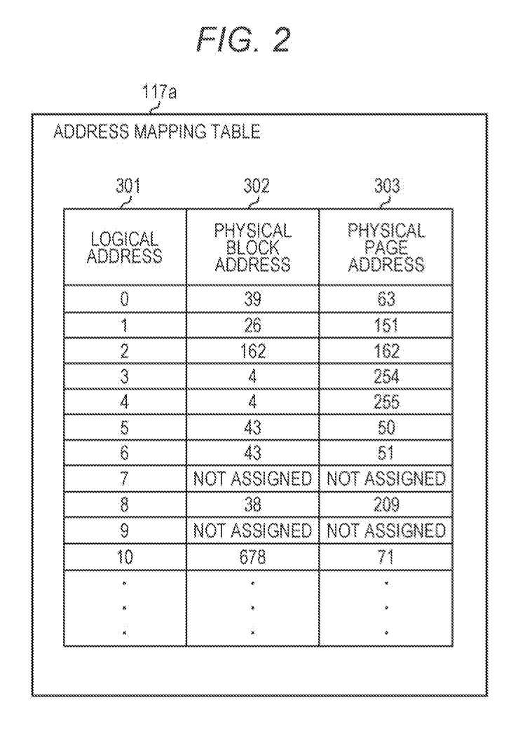

FIG. 2 is a diagram showing a configuration of address mapping table 117a in the present exemplary embodiment. Address mapping table 117a is a table storing information representing correspondence between logical address 301 used by host device 200 and physical address (specifically, physical block address 302 and physical page address 303) of non-volatile memory 120.

In FIG. 2, in address mapping table 117a, the logical address “0” corresponds to the physical block address “39” and the physical page address “63” and that the logical address “1” corresponds to the physical block address “26” and the physical page address “151”. Also regarding the logical address “2” and the following logical addresses, address mapping table 117a similarly stores the correspondence to the physical block addresses and the physical page addresses. Further, any of the logical block “7” and the logical block “9” is not assigned a physical address but stores a value indicating “not assigned”.

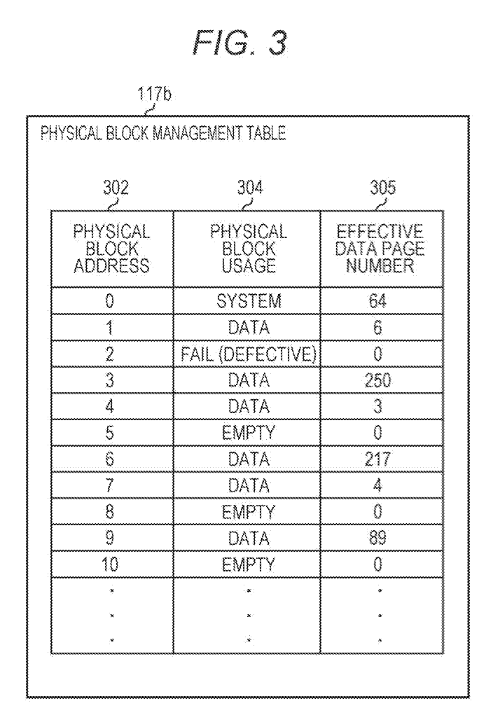

FIG. 3 is a diagram showing a configuration of physical block management table 117b in the present exemplary embodiment. In order to manage a state of usage of each of physical blocks constituting non-volatile memory 120, physical block management table 117b stores physical block address 302, physical block usage 304, and effective data page number 305 in association with each other. With reference to FIG. 3, physical block usage 304 stores usage of the physical block indicated by physical block address 302.

The indication of “system” in physical block usage 304 indicates that the corresponding physical block stores system information (various types of parameter information; a program to be loaded in RAM 118; information related to address mapping table 117a; physical block management table 117b; and discard object data information 117c stored in the control information storage; and other information) that is internally managed by non-volatile storage device 100.

The indication of “data” in physical block usage 304 indicates that the corresponding physical blocks store the data written by host device 200.

The indication of “fail (defective)” in physical block usage 304 indicates that the corresponding physical block is an innate or acquired defective block and is not used to store data.

The indication of “empty” in physical block usage 304 indicates that the corresponding physical blocks are empty (not used) and can be used for writing new data from host device 200 and writing data in the garbage collection process.

With reference to FIG. 3, effective data page number 305 stores the number of pages which are of the physical pages included in the corresponding physical block and in which there is valid data when physical block usage 304 of physical block indicated by physical block address 302 is “system” or “data”. When physical block usage 304 is “system”, the valid data indicates system information. When physical block usage 304 is “data”, the valid data is the latest data of the data written in the same logical address by host device 200. For example, in the case where host device 200 writes in the same logical address for three times, only the data written for the third time is valid data, and the data written for the first or second time is not valid data (invalid data).

In FIG. 3, in physical block management table 117b, the physical block usage corresponding to the physical block address “0” is “system”, and the effective data page number is “64”. The physical block usage corresponding to the physical block address “1” is “data”, and the effective data page number is “6”. Also regarding the physical block address “2” and the following physical block addresses, the information about the physical block usage and the effective data page number is stored.

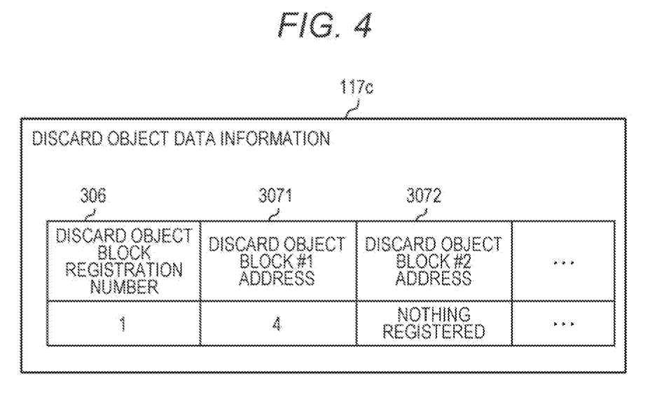

FIG. 4 is a diagram showing a configuration of discard object data information 117c in the present exemplary embodiment. The discard object data information 117c stores (i) the discard object block registration number 306 that is the number of registered physical blocks (discard object blocks) including the data to be discarded and (ii) the discard object block #1 address 3071, the discard object block #2 address 3072, . . . (repeated for the number of times corresponding to the number of the registered discard object blocks), each of which is physical block address 302 of each of the discard object blocks.

In FIG. 4, the discard object block registration number 306 is “1”, and the discard object block #1 address 3071 is “4”.

### [1-1-3. Configuration of Non-Volatile Memory]

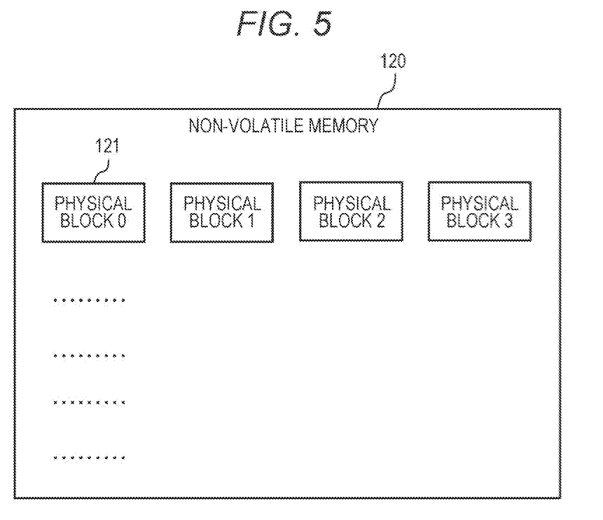

Next, a configuration of non-volatile memory 120 of non-volatile storage device 100 will be described. FIG. 5 is a diagram showing a configuration of physical blocks as a recording area in non-volatile memory 120 in the present exemplary embodiment.

Non-volatile memory 120 is configured with a plurality of physical blocks 121. Physical block 121 is a unit of erasure, and physical erasure of data is performed by this unit. In order to store data in non-volatile memory 120, the data needs to be written after data is physically erased by the unit of physical block 121. It is not allowed to write new data before the data in physical block 121 is physically erased.

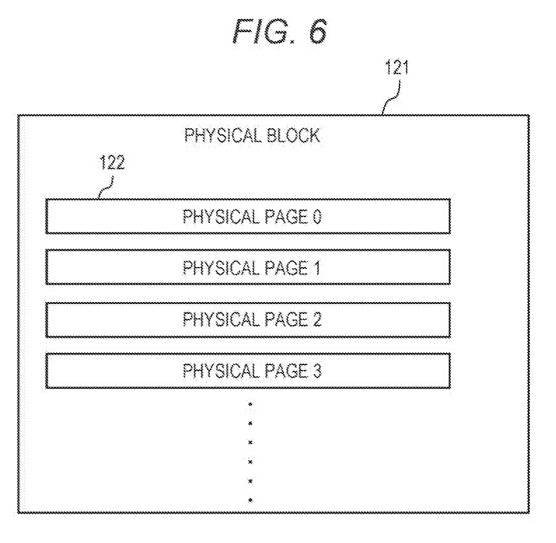

FIG. 6 is a diagram showing a configuration of physical block 121 in the present exemplary embodiment.

Physical block 121 is configured with a plurality of physical pages 122. Physical page 122 is a unit by which data is written into physical block 121.

In the present exemplary embodiment, the unit of physical page is 16 kB, and a unit of physical block is 4 MB, which is 16 kB×256 pages.

### [1-1-4. Configuration of Host Device]

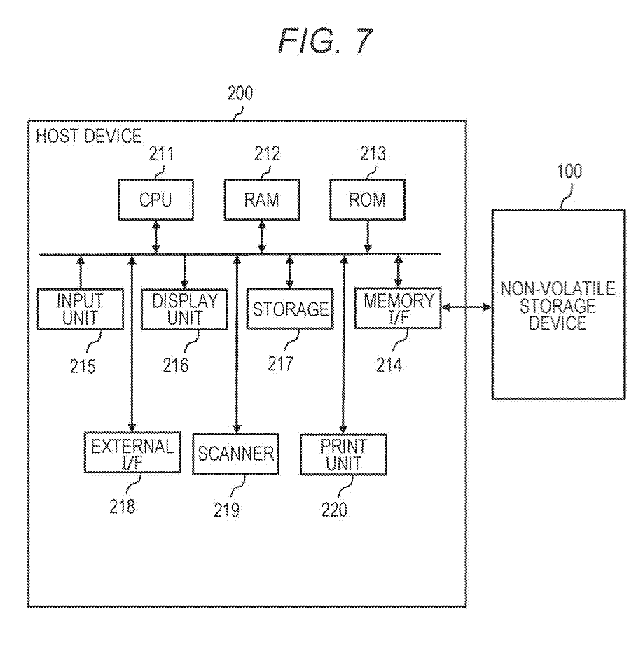

Next, a configuration of host device 200 will be described. FIG. 7 is a configuration diagram showing host device 200 in the present exemplary embodiment.

Host device 200 is a device connectable to non-volatile storage device 100.

Host device 200 includes CPU 211, RAM 212, ROM 213, and memory interface unit (memory I/F) 214 and these components are connected to each other via a bus. Host device 200 also includes input unit 215, display unit 216, storage 217, external interface unit (external I/F) 218, scanner 219, and print unit 220, and these components are connected to each other via a predetermined interface and the bus.

CPU 211 is a processing unit that executes various application programs and the like. RAM 212 is used as a storage area and a work area for a program to be executed by CPU 211 and for a parameter appropriately changing in a program manipulation. ROM 213 stores programs to be executed by CPU 211 or fixed data as an operation parameter.

Memory interface unit 214 is an interface that transmits and receives data such as commands and contents data to and from non-volatile storage device 100, under control of CPU 211.

Input unit 215 is a key, a button, a touch panel, a mouse, a keyboard, or the like to be operated by a user to input various instructions into CPU 211.

Display unit 216 is, for example, a liquid crystal display, an organic electro luminescence (EL) display, or the like and displays various types of information in text, image, or the like.

Storage 217 has, for example, a flash memory and a hard disk as an information storage medium.

External interface unit 218 is an interface that transmits and receives commands, contents data, and the like to and from another host device such as a personal computer, and is the Ethernet (registered trademark), a wireless LAN, or the like.

Scanner 219 is a function block to acquire information recorded on paper by converting the data into electronic data.

Print unit 220 is a function block to output the electronic data by printing on paper.

### [1-2. Operation]

An operation of non-volatile storage device 100 configured as described above will be described below.

### [1-2-1-1. Operation After Power-On]

First, an operation after power-on of non-volatile storage device 100 will be described.

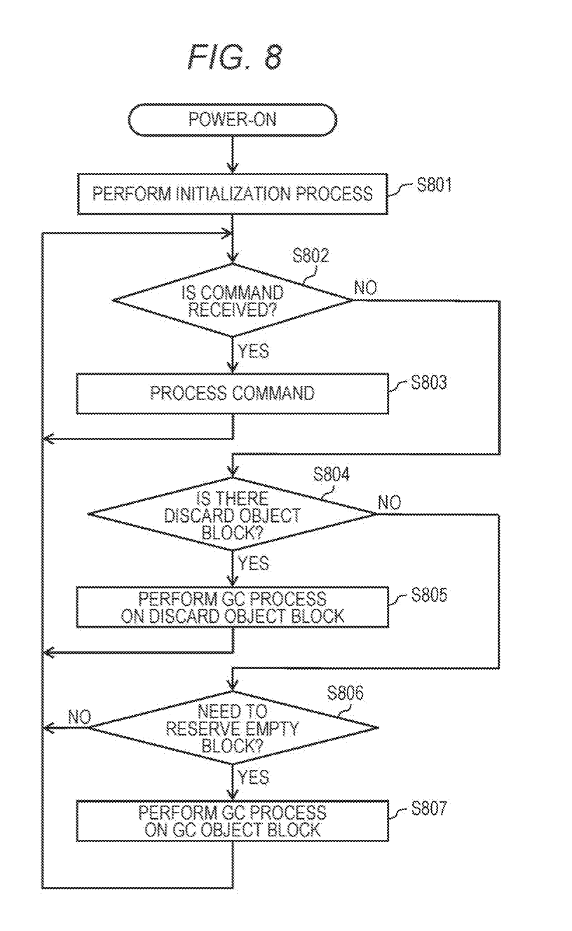

FIG. 8 is a flowchart showing an operation of non-volatile storage device 100 in the present exemplary embodiment after power is turned on.

Before host device 200 writes contents data or reads contents data in or from non-volatile storage device 100, non-volatile storage device 100 is powered on.

(Step S801) After non-volatile storage device 100 is powered on, an initialization process of memory controller 110 is performed to enable memory controller 110 to receive various commands from host device 200. Specifically, memory controller 110 performs execution of a program stored in ROM 119, an initialization process to access non-volatile memory 120, reading out system information stored in non-volatile memory 120, loading a program in RAM 118, setting of information in control information storage 117, and other processes.

(Step S802) Next, memory controller 110 checks whether a command is received from host device 200. If a command is received (in the case of Yes), the process proceeds to step S803, and if a command is not received (in the case of No), the process proceeds to step S804.

(Step S803) Memory controller 110 checks the type of the received command and performs a process depending on the type of the command. The process depending on each type of command will be described later. (Step S804) Memory controller 110 determines presence or absence of a discard object block, by referring to discard object data information 117c of control information storage 117 and checking whether discard object block registration number 306 is greater than or equal to 1. If discard object block registration number 306 is greater than or equal to 1 (in the case of Yes), the process proceeds to step S805, and if discard object block registration number 306 is 0 (in the case of No), the process proceeds to step S806.

(Step S805) Memory controller 110 performs a GC and data discard process on the discard object block. The GC and data discard process will be described later in detail.

(Step S806) Memory controller 110 determines whether it is necessary to reserve an empty block by referring to physical block management table 117b of control information storage 117 and checking whether the number of the physical blocks corresponding to “empty” in physical block usage 304 is less than a predetermined number N. If the number of the physical blocks corresponding to “empty” is less than the predetermined number N (in the case of Yes), the process proceeds to step S807, and if the number of the physical blocks corresponding to “empty” is greater than or equal to the predetermined number N (in the case of No), the process proceeds to step S802.

(Step S807) Memory controller 110 refers to physical block management table 117b of control information storage 117, chooses as a GC object block the block whose physical block usage is “data” and the value of whose effective data page number 305 is the minimum, and performs the GC and data discard process on the chosen block. The GC and data discard process will be described later in detail.

As shown in the flowchart of FIG. 8, in the present exemplary embodiment, the discard object block is preferentially chosen as an object of the GC and data discard process, and it is thus possible to physically erase the discard object block containing confidential data and the like promptly.

### [1-2-1-2. Operation of Writing Data]

Next, an operation of writing data in non-volatile storage device 100 will be described. Specifically, a description will be made on an operation when the type of the command is a data write command in step S803.

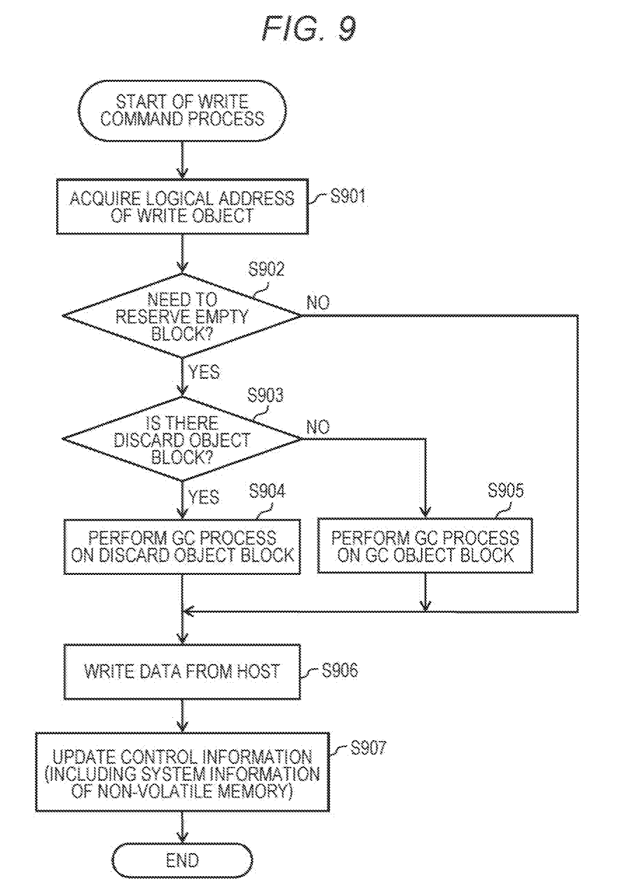

FIG. 9 is a flowchart showing an operation of non-volatile storage device 100 in the present exemplary embodiment when a data write command has been received.

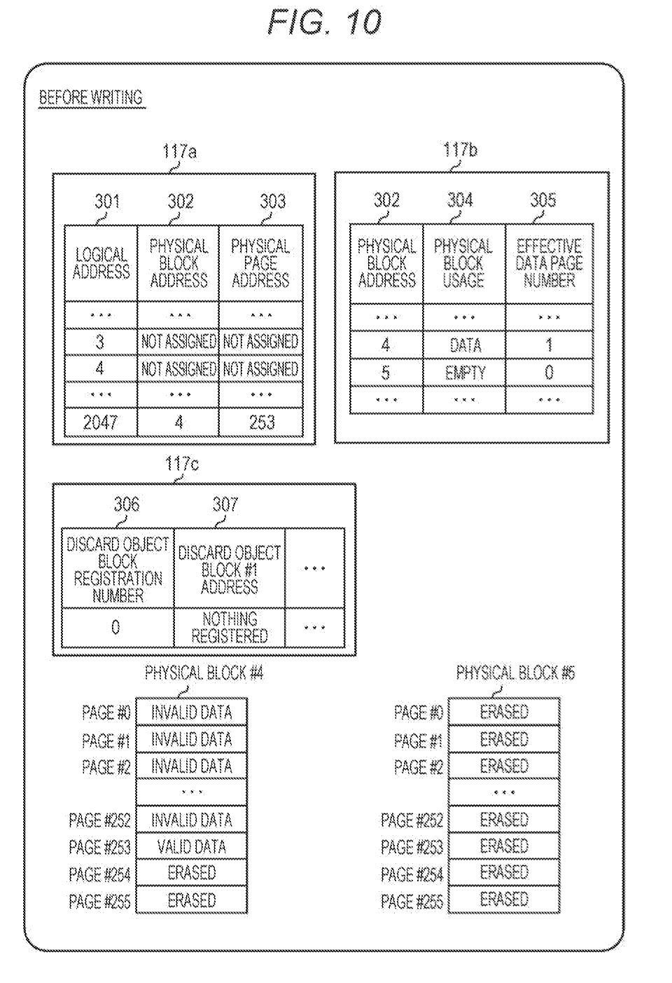

The description will be given below supposing that the state is as shown in FIG. 10 at a start time of this flowchart (address mapping table 117a, physical block management table 117b, and discard object data information 117c; data has been written from the first page to physical page #253 of physical block #4; and all the pages of physical block #5 have been erased).

When host device 200 writes contents data in non-volatile storage device 100, host device 200 informs memory controller 110 of non-volatile storage device 100 by issuing a write command while specifying a write address.

(Step S901) Host interface unit 111 of memory controller 110 receives the write command and the logical address of the write destination. The following operation of writing is described in the case where the write destination is two sections corresponding to the logical addresses “3” to “4”. In the present exemplary embodiment, one section corresponding to a logical address is 16 kB, and data for one logical address can be stored in one physical page.

(Step S902) Next, on CPU 101, write controller 112 determines whether there is a need for reserving an empty block to store write data. In the case (A) where there is a physical block whose physical block usage 304 of physical block management table 117b is “data” and in which data has been written up to a page in the middle, and data can be additionally written in the following pages, or in the case (B) where there are a predetermined number M or more of physical blocks in physical block management table 117b whose physical block usages 304 are “empty”, and one of such physical blocks can be reserved for writing data (in the case of No), the process goes to step S906. If the case is neither (A) nor (B) (in the case of Yes), the process proceeds to step 903. In the state as shown in FIG. 10, there is a physical block (physical block #4) corresponding to the case (A), and the process therefore proceeds to step S906.

(Step S903) On CPU 101, it is determined whether there is a discard object block, by referring to discard object data information 117c of control information storage 117 and by checking whether the discard object block registration number 306 is greater than or equal to 1. If discard object block registration number 306 is greater than or equal to 1 (in the case of Yes), the process proceeds to step S904, and if discard object block registration number 306 is 0 (in the case of No), the process proceeds to step S905.

(Step S904) On CPU 101, the GC and data discard process is performed on the discard object block. The GC and data discard process will be described later in detail. By performing the GC and data discard process, a predetermined number M or more of physical block whose physical block usages 304 are “empty” are made to exist in physical block management table 117b, and the process proceeds to step S906 with one of such physical blocks being reserved for writing data.

(Step S905) On CPU 101, physical block management table 117b of control information storage 117 is referred to, and the block whose physical block usage is “data” and whose effective data page number 305 is the minimum value is chosen as a GC object block; then the GC and data discard process is performed on the chosen block. The GC and data discard process will be described later in detail. By performing the GC and data discard process, a predetermined number M or more of physical block whose physical block usages 304 are “empty” are made to exist in physical block management table 117b, and the process goes to step S906 with one of such physical blocks being reserved for writing data.

(Step S906) On CPU 101, write controller 112 writes the write data received from host device 200 via host interface unit 111 in the physical block reserved in step S902, S904, or S905. In the state shown in FIG. 10, the data is written in physical block #4. Since the logical addresses for two sections are received in step S901, data of 16 kB×2 sections=32 kB, which is data for two physical pages, is written in physical block #4.

(Step S907) Next, on CPU 101, depending on the writing of data in step S906, write controller 112 updates address mapping table 117a and physical block management table 117b of control information storage 117. Further, in conformity with the updated contents of address mapping table 117a and physical block management table 117b, write controller 112 updates also the system information stored in non-volatile memory 120 and finishes the process for the write command.

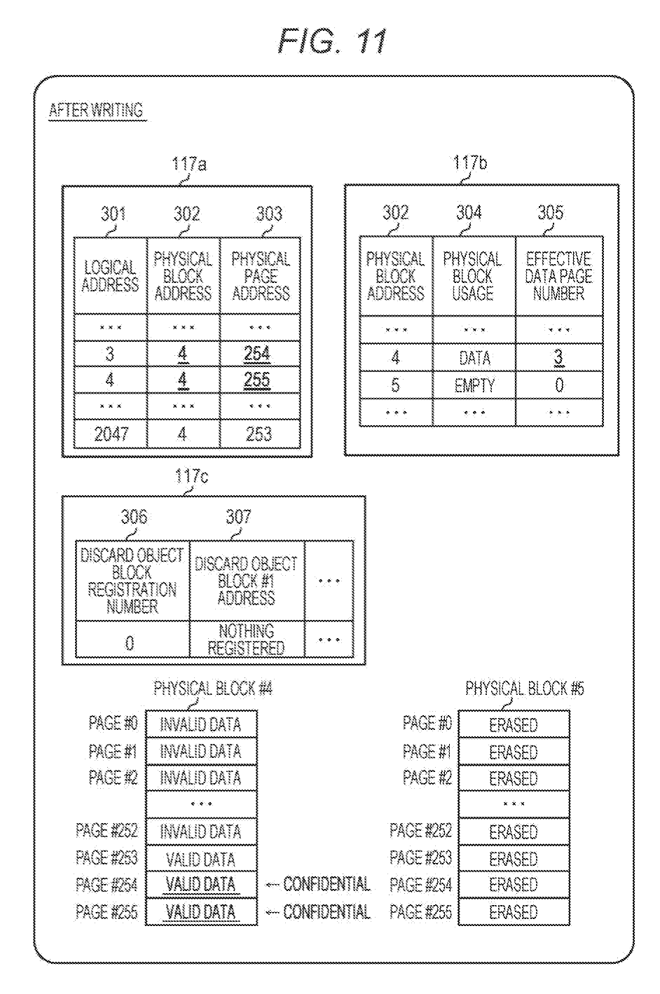

FIG. 11 shows the states of address mapping table 117a, physical block management table 117b, discard object data information 117c, physical block #4, physical block #5 after the write command is processed. The write data, at the logical addresses “3” and “4”, received from host device 200 is stored in physical pages #254 and #255 of physical block #4.

Hereinafter, the operation until the confidential data is physically discarded will be sequentially described, supposing that the data written at the logical addresses “3” and “4” is physically discarded as confidential data that will become necessary to be discarded.

### [1-2-1-3. Operation of Registering Data for Discard]

Next, an operation of registering data for discard in non-volatile storage device 100 will be described. Specifically, a description will be made on an operation in the case where the type of the command is a discard registration command in step S803.

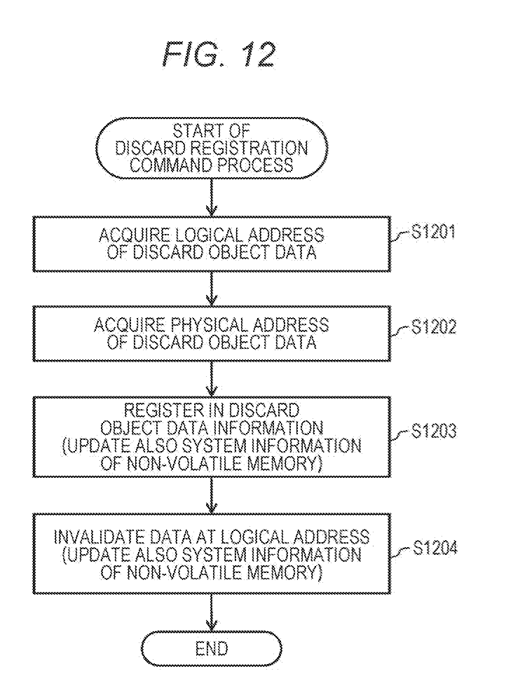

FIG. 12 is a flowchart showing an operation of non-volatile storage device 100 in the present exemplary embodiment when the discard registration command has been received.

The description will be given below supposing that the state is as shown in FIG. 11 at a start time of this flowchart (address mapping table 117a, physical block management table 117b, and discard object data information 117c; data has been written on all the pages of physical block #4; and all the pages of physical block #5 have been erased).

In order to physically discard the confidential data written in non-volatile storage device 100, host device 200 informs memory controller 110 of non-volatile storage device 100 by issuing a discard registration command while specifying the logical address of the discard object data.

(Step S1201) Host interface unit 111 of memory controller 110 receives the discard registration command and the logical address of the discard object data. Hereinafter, the registration discard operation will be described in the case where the logical addresses of the discard object data are “3” to “4” corresponding to two sections.

(Step S1202) Next, on CPU 101, data discard controller 114 refers to address mapping table 117a of control information storage 117 and thus obtains physical block address 302 corresponding to the designated logical addresses. The physical block address corresponding to the designated logical addresses “3” and “4” is “4”.

(Step S1203) Next, on CPU 101, data discard controller 114 registers physical block address “4” obtained in step S1202 in discard object data information 117c of control information storage 117. Specifically, data discard controller 114 updates discard object block registration number 306 of discard object data information 117c from “0” to “1” and updates discard object block #1 address 3071 from “nothing registered” to “4” (which is the physical block address obtained in step S1202). Further, in conformity with the updated contents of discard object data information 117c, the system information stored in non-volatile memory 120 is also updated.

(Step S1204) Next, on CPU 101, in address mapping table 117a of control information storage 117, data discard controller 114 invalidates logical block addresses “3” and “4” obtained in step S1201. Specifically, physical block address 302 and physical page address 303 respectively corresponding to “3” and “4” in logical address 301 of address mapping table 117a are updated to “not assigned”. Further, in conformity with the updated contents of address mapping table 117a, system information stored in non-volatile memory 120 is also updated, and the process for the discard registration command is finished.

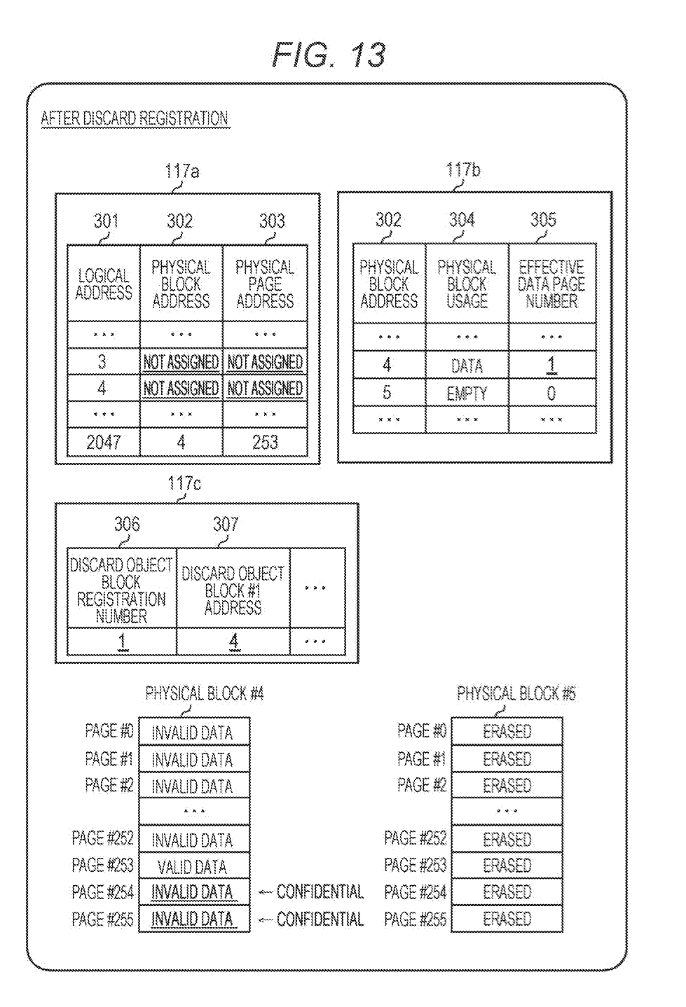

FIG. 13 shows the states of address mapping table 117a, physical block management table 117b, discard object data information 117c, physical block #4, physical block #5 after the discard registration command is processed. Physical block #4 storing the data corresponding to the logical addresses “3” and “4” received from host device 200 is registered in discard object data information 117c. In address mapping table 117a, since logical addresses “3” and “4” each show that the physical address is not assigned, the confidential data stored in physical pages #254 and #255 of physical block #4 is logically invalid. However, the confidential data exists physically.

In the case where host device 200 reads out data at logical addresses “3” and “4” in the state of FIG. 13, that is, in the case where the type of command is a read command in step S803, the read controller (not shown) on CPU 101 of memory controller 110 refers to address mapping table 117a of control information storage 117 and thus checks that physical block addresses 302 corresponding to the designated logical addresses each show “not assigned”, then outputs predetermined fixed values (for example, all 0xFF) as the data at logical addresses “3” and “4” to host device 200 via host interface unit 111. As a result, the confidential data stored on physical pages #254 and #255 of physical block #4 is not output to host device 200 via host interface unit 111.

As shown in the flowchart of FIG. 12, in the present exemplary embodiment, when discard object data information 117c is updated, the system information stored in non-volatile memory 120 is also updated. By this operation, even in a case where unintended power-off occurs while a discard registration command is being performed, when non-volatile storage device 100 performs a power-on operation again, discard object data information 117c can be restored on the basis of the system information stored in non-volatile memory 120, and the data discard process on the discard object blocks is surely continued.

In addition, as shown in the flowchart of FIG. 12, in the present exemplary embodiment, the data at the designated logical address is invalidated in address mapping table 117a after discard object data information 117c is updated. By this operation, in a case where unintended power-off occurs before discard object data information 117c is updated, host device 200 detects that confidential data remains by reading out the data at the designated logical address; therefore, it is possible to perform processing again from the process of registering for discard, whereby the data discard process can be surely continued.

### [1-2-1-4. Operation of Acquiring Discard-State of Data]

Next, a description will be made on an operation of acquiring a discard-state of data in non-volatile storage device 100. Specifically, the description will be made on the operation in the case where the type of the command is a discard-state acquisition command in step S803.

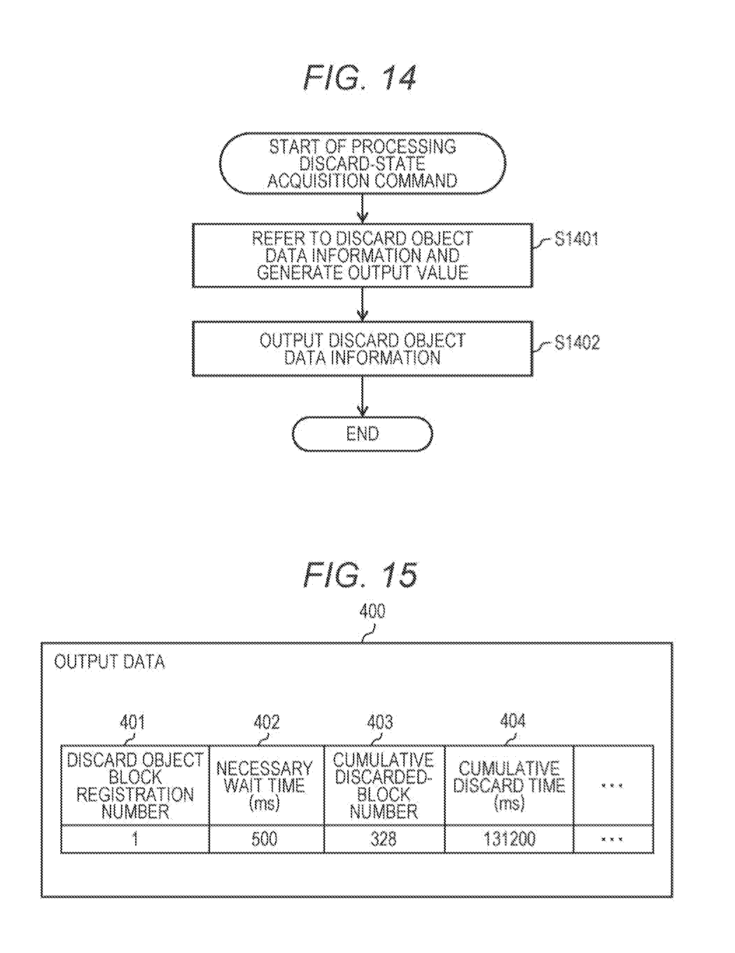

FIG. 14 is a flowchart showing an operation of non-volatile storage device 100 in the present exemplary embodiment when a discard-state acquisition command has been received.

FIG. 15 shows output data 400 as a response to a discard-state acquisition command. Output data 400 is a table storing at least discard object block registration number 401, necessary wait time 402, cumulative discarded-block number 403, and cumulative discard time 404.

The description will be given below supposing that the state is as shown in FIG. 13 at a start time of this flowchart (address mapping table 117a, physical block management table 117b, and discard object data information 117c; data has been written on all the pages of physical block #4; and all the pages of physical block #5 have been erased).

In order to check the discard state of the confidential data written in non-volatile storage device 100, host device 200 informs memory controller 110 of non-volatile storage device 100 by issuing a discard-state acquisition command.

(Step S1401) Host interface unit 111 of memory controller 110 informs CPU 101 that host interface unit 111 has received the discard-state acquisition command. On CPU 101, data discard controller 114 refers to discard object data information 117c of control information storage 117 to obtain the value of discard object block registration number 306 and sets the obtained value as an output value (discard object block registration number 401).

Further, data discard controller 114 refers to the value at address 307 of discard object block #1 to obtain the physical block address of the discard object block. Then, data discard controller 114 obtains the effective data page number included in the discard object block by referring to physical block management table 117b, calculates time necessary for performing the GC and data discard process (to be described later) on the discard object block, and sets the calculated value as an output value (necessary wait time 402). Note that the time necessary to perform the GC and data discard process is calculated by a formula: (the effective data page number)×(a copy time per one page [a fixed value])+(time for other processes [a fixed value]).

Further, data discard controller 114 obtains a cumulative discarded-block number (not shown) by referring to discard object data information 117c of control information storage 117 and sets the obtained time as an output value (cumulative discarded-block number 403). Here, the cumulative discarded-block number is the number of times that the discard object block registered by a discard registration command is subjected to the GC and data discard process to be described later and is a cumulative value since non-volatile storage device 100 was manufactured.

Further, data discard controller 114 obtains cumulative discard time (not shown) by referring to discard object data information 117c of control information storage 117 and sets the obtained time as an output value (cumulative discard time 404). Here, the cumulative discard time is the time taken for the GC and data discard process (to be described later) to be performed on the discard object block registered by a discard registration command and is a cumulative value since non-volatile storage device 100 was manufactured. The cumulative discard time may be determined by measuring time actually taken and by adding the measured time, or may be determined by adding necessary wait time calculated for each discard object block.

(Step S1402) Next, host interface unit 111 outputs each value of output data 400 prepared in step S1401 to host device 200.

By performing the above process, the output data 400 as a response to the discard-state acquisition command becomes as shown in FIG. 15. Discard object block registration number 401 is “1”. Necessary wait time 402, which is the wait time necessary to perform a data discard process on this one discard object block, is 500 ms. Further, the cumulative discarded-block number, which is the number of times of performing a data discard process until now, is 328, and cumulative discard time 404 having been taken to perform these data discard processes is 131,200 ms.

Host device 200 can check the state of the currently remaining data discard process by referring to discard object block registration number 401 and necessary wait time 402, and host device 200 can make non-volatile storage device 100 perform the GC and data discard process to be described later, as needed.

Further, host device 200 can check a throughput having been required for the data discard processes by referring to cumulative discarded-block number 403 and cumulative discard time 404. If host device 200 is under development, it is possible to adjust how to perform a data discard process (for example, to collectively register a plurality pieces of confidential data for discard) while checking the throughput.

### [1-2-1-5. GC and Data Discard Operation]

Next, a GC and data discard operation in non-volatile storage device 100 will be described. Specifically, the operations in steps S805, S807, S904, S905 will be described in detail.

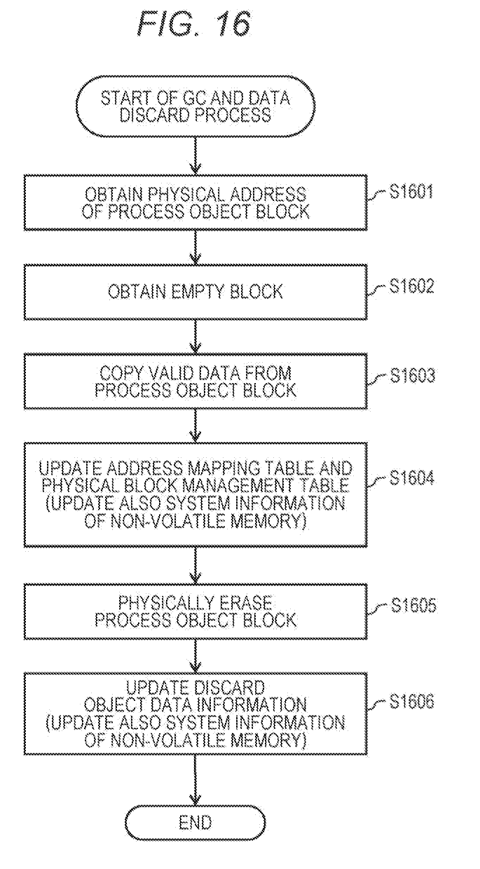

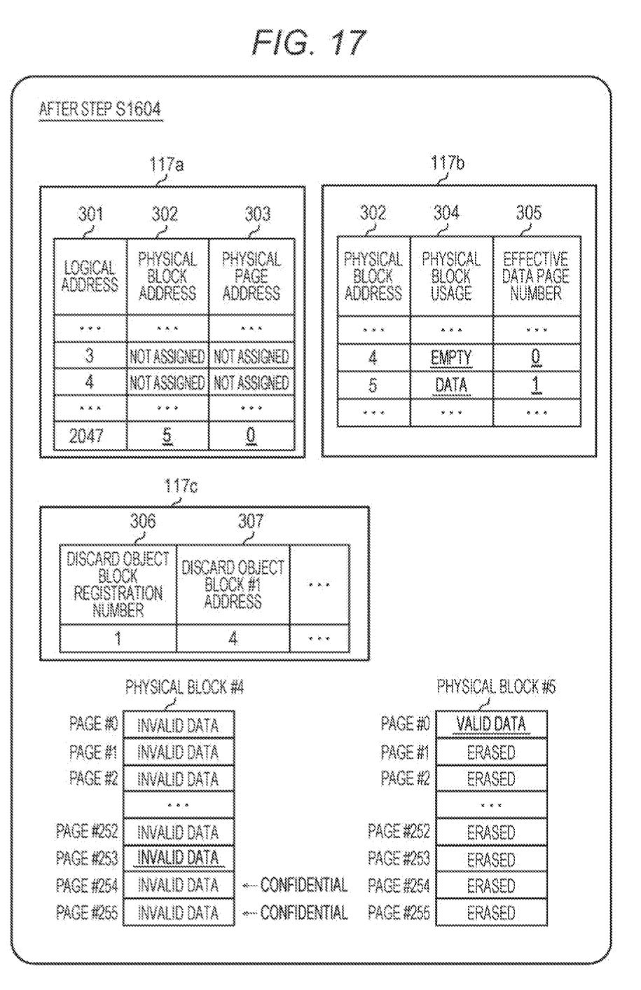

FIG. 16 is a flowchart showing an operation of the GC and data discard process in the present exemplary embodiment.

The description will be given below supposing that the state is as shown in FIG. 13 at a start time of this flowchart (address mapping table 117a, physical block management table 117b, and discard object data information 117c; data has been written on all the pages of physical block #4; and all the pages of physical block #5 have been erased).

In order to prompt physical discard of the confidential data written in non-volatile storage device 100, host device 200 temporarily waits while issuing no command to non-volatile storage device 100 and informs memory controller 110 of non-volatile storage device 100 that there is no command issued.

(Step S1601) On CPU 101 of memory controller 110, GC controller 113 obtains the physical block address of the process object block. If the process is for step S805 or S904, the process object block is a discard object block, and physical block address “4” is obtained by referring to discard object block #1 address 3071 of discard object data information 117c of control information storage 117. If the process is for step S807 or S905, the process object block is a GC object block, and the physical block address is obtained by referring to physical block management table 117b of control information storage 117.

(Step S1602) Next, on CPU 101, GC controller 113 refers to physical block management table 117b and obtains physical block #5, whose physical block usage 304 is “empty”.

(Step S1603) Next, on CPU 101, GC controller 113 copies all valid data included in process object block (physical block #4) in the empty block (physical block #5). GC controller 113 refers to address mapping table 117a and searches for an entry whose physical block address 302 is “4”. Then, GC controller 113 refers to physical page address 303 corresponding to the entry whose physical block address 302 is “4” and reads out the data in the physical page (physical page #253), then writes (copies) the data in the empty block (physical block #5).

(Step S1604) Next, on CPU 101, in order to validate the data (data in physical block #5) written in step S1603, GC controller 113 updates address mapping table 117a and physical block management table 117b of control information storage 117. Further, in conformity with the updated contents of address mapping table 117a and physical block management table 117b, GC controller 113 also updates the system information stored in non-volatile memory 120.

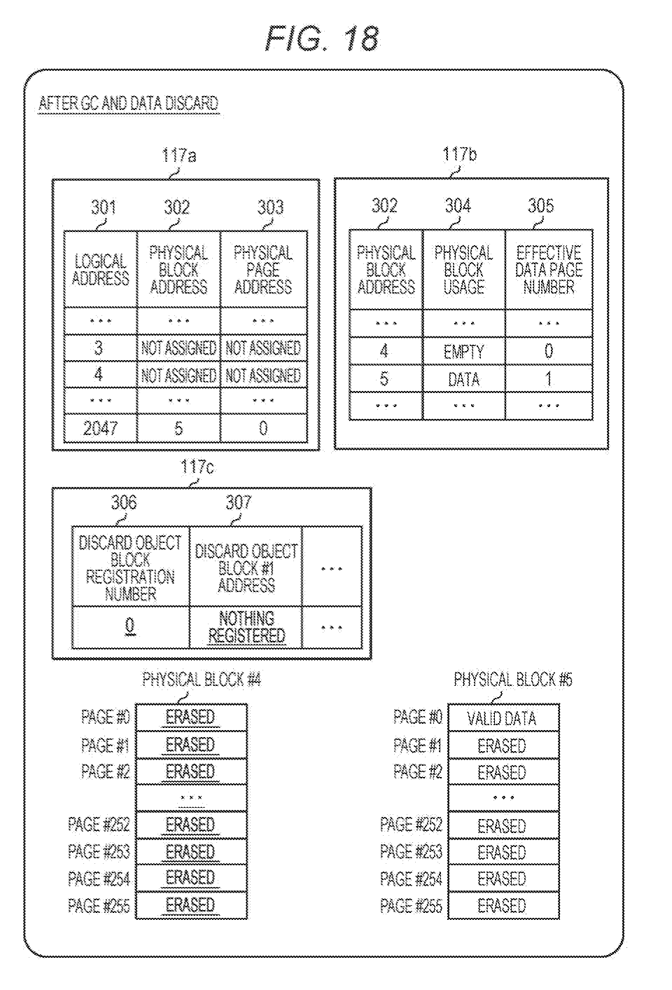

FIG. 17 shows the states of address mapping table 117a, physical block management table 117b, discard object data information 117c, physical block #4, physical block #5 after the process of step S1604 is performed. In address mapping table 117a, the physical address corresponding to logical address #2047 is updated to physical page #0 of physical block #5. In physical block management table 117b, the usage of physical block #4 is “empty”, the usage of physical block #5 is “data”, and the effective data page number is updated to “1”.

(Step S1605) Next, on CPU 101, data discard controller 114 physically erases physical block #4, which became “empty” in step S1604. By this operation, the confidential data having existed in physical page #254 and physical page #255 of physical block #4 is physically discarded.

(Step S1606) Next, on CPU 101, data discard controller 114 updates discard object data information 117c of control information storage 117. Data discard controller 114 updates discard object block registration number 306 from “1” to “0” and updates discard object block #1 address 3071 from “4” to “nothing registered”. Further, in conformity with the updated contents of discard object data information 117c, data discard controller 114 also updates the system information stored in non-volatile memory 120 and finishes the GC and data discard process.

FIG. 18 shows the states of address mapping table 117a, physical block management table 117b, discard object data information 117c, physical block #4, physical block #5 after the GC and data discard process is performed. The confidential data having existed in physical page #254 and physical page #255 of physical block #4 is physically discarded by physical erasure.

As shown in the flowchart of FIG. 16, in the present exemplary embodiment, discard object data information 117c is updated after the process object block is physically erased. By this operation, even in a case where unintended power-off occurs while the GC and data discard process is being performed, when non-volatile storage device 100 performs a power-on operation again, discard object data information 117c can be restored on the basis of the system information stored in non-volatile memory 120, and the data discard process on the discard object blocks is surely continued.

Further, as shown in the flowchart of FIG. 16, also when the process object is not a discard object block but a GC object block, the copy source physical block is physically erased in step S1605. This operation prevents confidential data from physically increasing due to the confidential data stored in non-volatile memory 120 being copied to another physical block by the garbage collection process inside non-volatile storage device 100 before the confidential data is registered by a discard registration command.

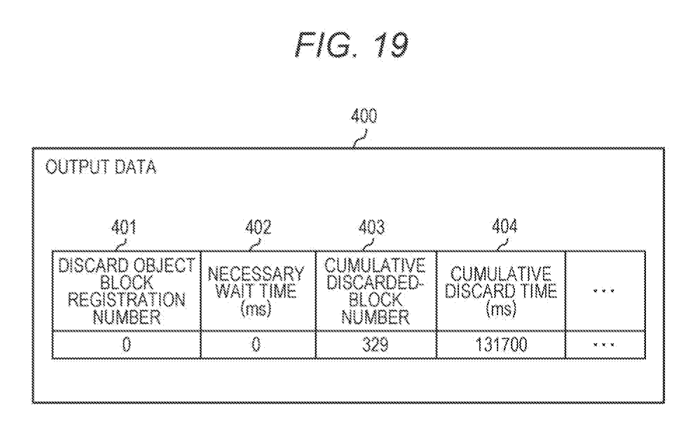

FIG. 19 shows an example of the output data when a discard-state acquisition command is issued after the GC and data discard process. In output data 400, discard object block registration number 401 is updated to “0”. In addition, since there is no discard object block, a data discard process does not need to be performed, and necessary wait time 402 is 0 ms. Further, the cumulative discarded-block number, which is the number of times of performing a data discard process until now, has been increased by 1 and is updated to 329, and cumulative discard time 404 required for these data discard processes is also updated to 131,700 ms.

Non-volatile storage device 100 operates as described above.

Next, an operation of host device 200 will be described below.

### [1-2-2-1. Operation After Power-On]

An operation of host device 200 after power-on will be described.

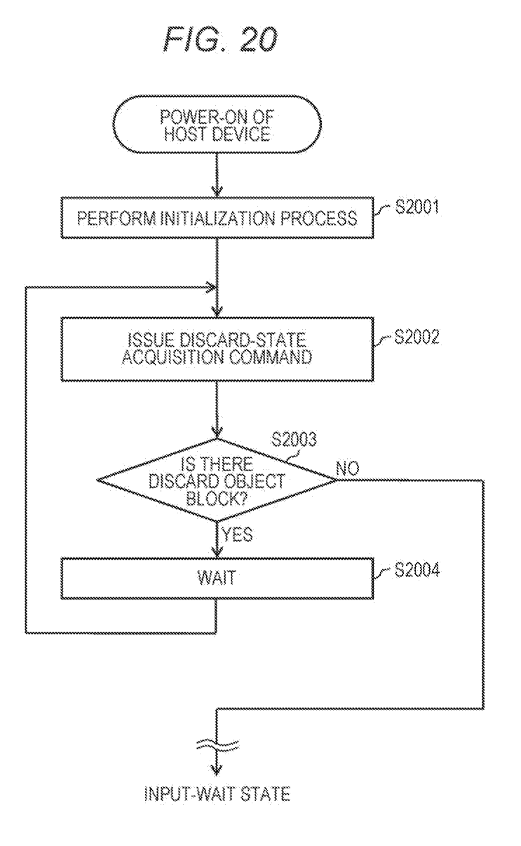

FIG. 20 is a flowchart showing an operation of host device 200 in the present exemplary embodiment after power is turned on;

(Step S2001) After power is turned on, host device 200 performs initialization processes (execution of a program stored in ROM 213, reading out information stored in storage 217, loading of a program in RAM 212, setting of memory interface unit 214, and the like) to make it possible to issue various commands to non-volatile storage device 100.

(Step S2002) Next, CPU 211 of host device 200 issues a discard-state acquisition command to non-volatile storage device 100.

(Step S2003) Next, CPU 211 of host device 200 refers to output data 400 as a response to the discard-state acquisition command to determine whether a discard object block remains inside non-volatile storage device 100. If discard object block registration number 401 is greater than or equal to 1 (in the case of Yes), the process of step S2004 is proceeded, and if discard object block registration number 401 is 0 (in the case of No), the initialization process is finished, and host device 200 transits to a state to wait for an input from a user.

(Step S2004) CPU 211 of host device 200 refers to output data 400 as a response to the discard-state acquisition command and waits for necessary wait time 402 (without issuing any command to non-volatile storage device 100), then proceeds to the process of step S2002.

As shown in the flowchart of FIG. 20, in the present exemplary embodiment, even in the case where a discard object block remains in non-volatile storage device 100 due to power-off or other reasons, it is possible to promptly perform a data discard process immediately after power is turned on.

### [1-2-2-2. Operation of Image Printing Process]

An operation of an image printing process on host device 200 will be described.

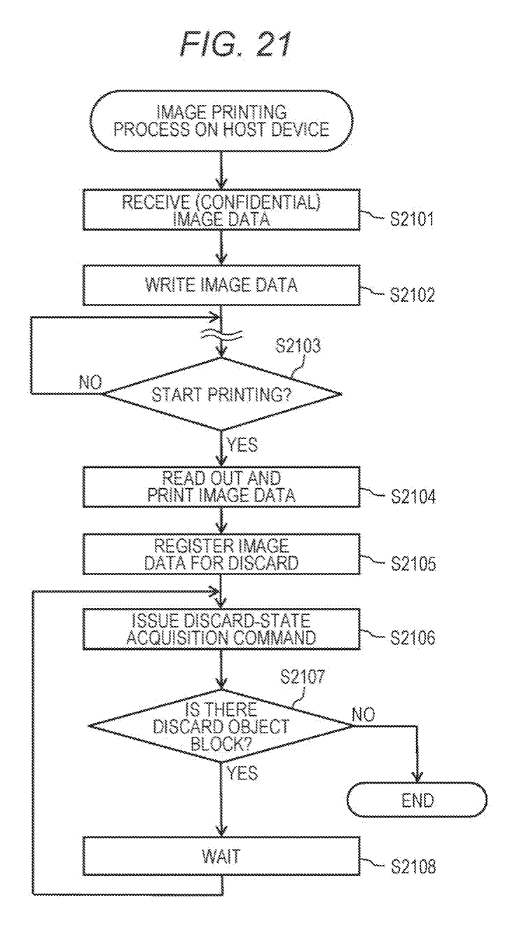

FIG. 21 is a flowchart showing an operation of an image printing process on the host device in the present exemplary embodiment.

(Step S2101) CPU 211 of host device 200 receives image data as a print object from another host device via external interface unit 218. In this case, the image data is confidential data and is required to be discarded promptly after being printed.

(Step S2102) Next, CPU 211 of host device 200 issues a write command to non-volatile storage device 100 to store the received image data in non-volatile storage device 100.

(Step S2103) Next, host device 200 waits until a user instructs to print the image data. If the user instructs via input unit 215 of host device 200 to print the image data (in the case of Yes), the flow proceeds to the process of step S2104.

(Step S2104) CPU 211 of host device 200 issues a read command to non-volatile storage device 100 to obtain the stored image data and prints the obtained image data on print unit 220.

(Step S2105) Next, CPU 211 of host device 200 issues a discard registration command to non-volatile storage device 100 while specifying the logical address of the stored image data.

(Step S2106) Next, CPU 211 of host device 200 issues a discard-state acquisition command to non-volatile storage device 100.

(Step S2107) Next, CPU 211 of host device 200 determines whether there is a discard object block in non-volatile storage device 100 by referring to output data 400 as a response to the discard-state acquisition command. If discard object block registration number 401 is greater than or equal to 1 (in the case of Yes), the process of step S2108 is proceeded, and if discard object block registration number 401 is 0 (in the case of No), the image processing is finished.

(Step S2108) CPU 211 of host device 200 refers to output data 400 as a response to the discard-state acquisition command and waits for necessary wait time 402 (without issuing any command to non-volatile storage device 100), then proceeds to the process of step S2106.

As shown in the flowchart of FIG. 21, in the present exemplary embodiment, immediately after image data (confidential data) becomes unnecessary, the image data is physically discarded.

### [1-2-2-3. Operation of Power-Off Process]

An operation of a power-off process on host device 200 will be described.

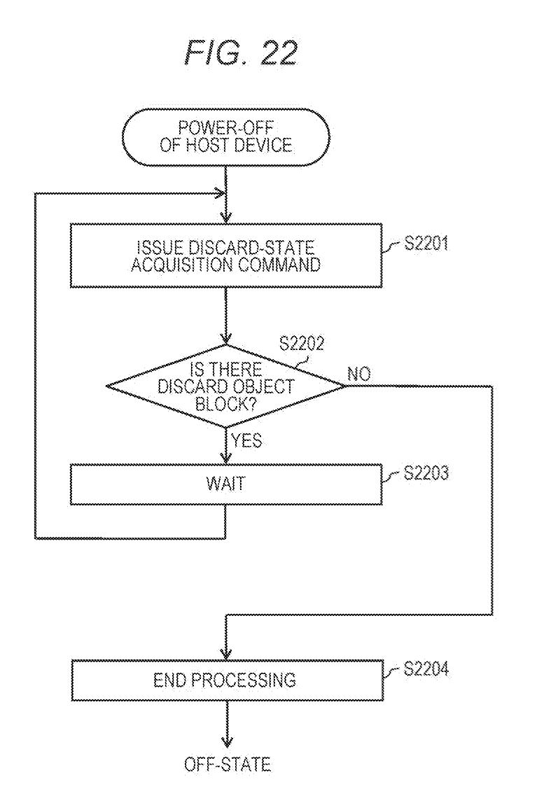

FIG. 22 is a flowchart showing an operation of power-off of host device 200 in the present exemplary embodiment.

(Step S2201) When host device 200 has received a request for power-off from a user of host device 200 via input unit 215, CPU 211 of host device 200 issues a discard-state acquisition command to non-volatile storage device 100.

(Step S2202) Next, CPU 211 of host device 200 refers to output data 400 as a response to the discard-state acquisition command to determine whether a discard object block remains in non-volatile storage device 100. If discard object block registration number 401 is greater than or equal to 1 (in the case of Yes), the process of step S2203 is proceeded, and if discard object block registration number 401 is 0 (in the case of No), the flow proceeds to the process of step S2204.

(Step S2203) CPU 211 of host device 200 refers to output data 400 as a response to the discard-state acquisition command and waits for necessary wait time 402 (without issuing any command to non-volatile storage device 100), then the flow proceeds to step S2201.

(Step S2204) Host device 200 performs end processing (storing in storage 217 information generated in RAM 212, displaying notification information on display unit 216, and the like) and transitions to a state where power can be turned off. After that host, device 200 turns power off.

As shown in the flowchart of FIG. 22, in the present exemplary embodiment, even in the case where a discard object block remains in non-volatile storage device 100 due to an interruption of processing caused by an error or other reasons, it is possible to surely perform a data discard process before power is turned off.

### [1-3. Effect and Other Benefits]

With the conventional non-volatile storage device, it is impossible to perform control in which a host device can check a state of confidential data stored in a non-volatile storage device and can physically discard the confidential data.

In view of the above, memory controller 110 according to the present exemplary embodiment includes data discard controller 114, and it can be checked from the host device side whether confidential data that is registered for discard remains. Further, it is possible to instruct from the host device side to physically erase the confidential data registered for discard.

Further, host device 200 according to the present exemplary embodiment instructs to physically erase confidential data immediately after the confidential data becomes unnecessary, and host device 200 checks whether the physical erasure has been completed. Therefore, measures in consideration of security are possible in which unnecessary confidential data is physically discarded promptly.

### Other Exemplary Embodiments

The first exemplary embodiment has been described above as an example of the techniques disclosed in the present disclosure. However, the techniques of the present disclosure can be applied not only to the above exemplary embodiment but also to exemplary embodiments in which modification, replacement, addition, or removal is appropriately made.

Then other exemplary embodiments will be described below as examples.

In the first exemplary embodiment, non-volatile storage device 100 starts a data discard operation immediately after no command is received from host device 200; however, an operation of data discard may be started after it is checked that a predetermined time has elapsed in a state where no command is received. By this operation, when host device 200 has a command to be performed preferentially to a data discard operation, such command can be received promptly and be processed.

In the first exemplary embodiment, a method is used in which, as a trigger for host device 200 to cause non-volatile storage device 100 to start a data discard operation, host device 200 waits while issuing no command to non-volatile storage device 100; however, the trigger is not limited to this method. Non-volatile storage device 100 may perform a data discard process when the host issues a command to instruct to perform discard.

In the first exemplary embodiment, individual blocks in memory controller 110 and host device 200 may be each configured with one chip made of a semiconductor circuit such as a large-scale integration (LSI), or a part or whole of the blocks may be made into one chip. The semiconductor circuits may be configured such that a predetermined function is realized only by a hardware configuration or such that a predetermined function may be realized by hardware in cooperation with software. For example, the semiconductor circuits are each configured with any of an application specific integrated circuit (ASIC), a field programmable gate array (FPGA), a CPU, a micro-processing unit (MPU), and a microcomputer.

Note that although LSI is mentioned above, the device is sometimes referred also to as integrated circuit (IC), system LSI, super LSI, or ultra LSI depending on integration degree. Further, a method for circuit integration is not limited to the LSI, and may be realized by a dedicated circuit or a general-purpose processor. It is also possible to use a field programmable gate array (FPGA) capable of being programmed after LSI fabrication or to use a reconfigurable processor in which connections and settings of circuit cells in the LSI can be reconfigured.

An execution order of the processing methods in the first exemplary embodiment is not necessarily limited to the order described in the above exemplary embodiment, and the execution order can be changed without departing from the gist of the present disclosure.

A scope of the present disclosure includes the following components according to the first exemplary embodiment: memory controller 110; non-volatile storage device 100 including memory controller 110 and non-volatile memory 120; and non-volatile storage system 1 including non-volatile storage device 100 and host device 200. The scope of the present disclosure further includes: memory control method according to the first exemplary embodiment; a computer program causing a computer to execute the memory control method; and a computer-readable recording medium recording the program. In this case, examples of the computer-readable recording medium include a flexible disk, a hard disk, a compact disc read only memory (CD-ROM), a magneto-optical disc (MO), a digital versatile disc (DVD), a DVD-ROM, a DVD-RAM, a Blu-ray (registered trademark) disc (BD), and a semiconductor memory.

The above computer program is not limited to a program recorded in the above recording medium but may be a program transmitted through an electric communication line, a wireless or wired communication line, a network represented by the internet, or the like.

As described above, the exemplary embodiment has been described as an example of the techniques in the present disclosure. For this purpose, the accompanying drawings and the detailed description have been provided.

Therefore, in order to illustrate the above techniques, the components described in the accompanying drawings and the detailed description can include not only components necessary to solve the problem but also components unnecessary to solve the problem. For this reason, it should not be immediately recognized that those unnecessary components are necessary just because those unnecessary components are described in the accompanying drawings and the detailed description.

Since the exemplary embodiments described above are intended to exemplify the techniques in the present disclosure, it is possible to make various changes, replacements, additions, omissions, or the like within the scope of the claims or the equivalent thereof.

The present disclosure is applicable to a storage device in which a non-volatile memory is embedded. Specifically, the present disclosure is applicable to an SSD, a memory card, a flash drive, a memory device for embedded use, and other devices.

What is claimed is:

1. A memory controller that writes and reads data into and from a non-volatile memory having a plurality of physical blocks, the memory controller comprising:
a control unit that manages:
an address mapping table that manages correspondence between a logical address designated by an external device and the plurality of physical blocks, and
discard object data information generated by converting data about a discard object designated by the logical address by the external device into information about the plurality of physical blocks, and
discards data based on the discard object data information; and
a host interface unit connected to the external device to transmit and receive data to and from the external device,
wherein
when the control unit has received an instruction to acquire a discard state of data from the host interface unit, the control unit outputs information about unprocessed discard object data with reference to the discard object data information.

2. The memory controller according to claim 1, wherein the control unit performs physical discard of data based on the discard object data information while the control unit is not receiving a command from the external device.

3. The memory controller according to claim 2, wherein the control unit physically erases the plurality of physical blocks as the physical discard of the data.

4. The memory controller according to claim 1, wherein when the control unit has received an instruction to acquire a discard state of data from the host interface unit, the control unit outputs, with reference to the discard object data information, a number of physical blocks where unprocessed discard object data is stored.

5. The memory controller according to claim 1, wherein when the control unit has received an instruction to acquire a discard state of data from the host interface unit, the control unit outputs predicted time necessary to process unprocessed discard object data with reference to the discard object data information.

6. A non-volatile storage device comprising:
the memory controller according to claim 1; and
a non-volatile memory that is connected to the memory controller and that the memory controller records data in.

7. A non-volatile storage system comprising:
the memory controller according to claim 1;
a non-volatile memory that is connected to the memory controller and that the memory controller records data in; and
an external device that is connected to the memory controller and transmits to the memory controller an instruction to acquire a discard state of data.

8. The non-volatile storage system according to claim 7, wherein the external device obtains information about unprocessed discard object data from the memory controller, and when unprocessed discard object data exists, the external device stops transmitting a command to the memory controller for a predetermined period of time.

9. A memory control method comprising:
discarding, by using a memory, data stored in a non-volatile memory having a plurality of physical block; the memory holding:
an address mapping table that manages correspondence between a logical address designated by an external device and the plurality of physical blocks, and
discard object data information generated by converting data about a discard object designated by the logical address by the external device into information about the plurality of physical blocks,
receiving an instruction to acquire a discard state of data from the external device; and
outputting information about unprocessed discard object data with reference to the discard object data information when the instruction to acquire a discard state of data has been received.
